(19) United States
(12) Patent Application Publication
(10) Pub. No.: US 2012/0001132 A1
(43) Pub. Date: Jan. 5, 2012

(54) Rechargeable Battery Cathode Material

(76) Inventor: Surajit Sengupta, Waterloo (CA)

(21) Appl. No.: 12/829,355

(22) Filed: Jul. 1, 2010

(51) Int. Cl. H01B 1/08

(52) U.S. Cl. 252/520.21

(57) ABSTRACT

A novel cathode material for a rechargeable battery has the chemical formula Li_{1.18}Co_{0.3}Mn_{0.33}Ni_{0.17}Ti_{0.02}O₂, and is made by mixing the starting soluble salts in distilled water, mixing the insoluble salts slowly with vigorous stirring at a temperature of 150° Celsius, heating the resulting gel at 600 degrees Celsius for four hours, crushing the dried material into a fine powder, and heating at higher temperatures in the range of 800 to 900 degrees Celsius, wherein the time for calcination is limited to a maximum 8-12 hours.

This application claims the benefit of the filing date of provisional application No. 61,222372, filed on Jul. 1, 2009.

### BACKGROUND

The present invention relates to the field of battery technology; and more particularly to a cathode material for optimizing the performance of a rechargeable battery; and still more particularly to an improved cathode material for batteries installed in an electric vehicle.

### SUMMARY

The chemical structure of the cathode material of the present invention is LiₐCo_{b}Mn_{c}Ni_{d}TiₑO₂ in a hexagonal lattice configuration. LiCoₓMn_{y}Ni_{z}O₂ is the basic material from which the final product is synthesized. The initial starting materials LiₓᵢCO_{y1}; Ti[O(CH_{z1})_{z2}]_{z3}; Mn₂O₃; Mn(NO₃)ₐ₁; _{b1}H2O; Nl(NO₃)ₑ₁; ₓH₂O; Co(NO₃)ₓ₂; ₓ₃H₂O; and Co(OH)_{z4} are mixed in distilled water and then insoluble salts are slowly mixed in at 150 degrees Celsius.

The resulting gel is heated at 600° Celsius for four hours to yield a solid product that is crushed into a fine powder. The powder is then heated at higher temperatures in the range of 800 to 900 degrees Celsius with the time for calcination limited to a maximum of 8 to 12 hours.

Testing by X-ray diffraction pattern has demonstrated that the structure is a hexagonal lattice without any defects.

### BRIEF DESCRIPTION OF THE FIGURES

FIG. 1 is a table illustrating the X-ray diffraction pattern of the cathode material.

FIG. 2 is an electron micrograph of the cathode material.

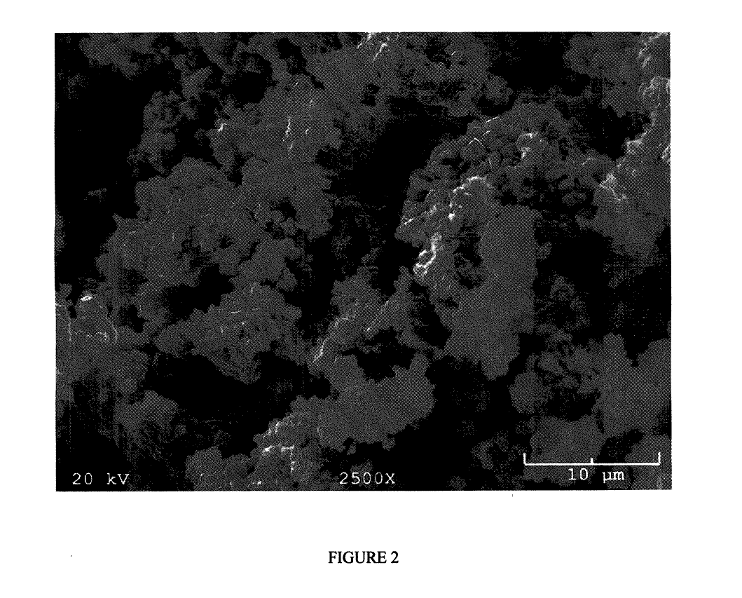

FIG. 3 is a table illustrating the discharge profile of a battery using the cathode material.

### DESCRIPTION

The elements comprising the cathode material comprise an initial basic structure; LiCoₓMn_{y}Ni_{z}O₂, which is synthesized into a final product with the stoichiometric formula LiₐCo_{b}Mn_{c}Ni_{d}TiₑO₂. The basic physical structure of the final product is a hexagonal lattice. In one preferred embodiment, the chemical formula is Li_{1.18}Co_{0.3}Mn_{0.3}Ni_{0.17}Ti_{0.02}O₂.

The percentage of each element that comprises the cathode.

The numbers of moles initially incorporated into the material are indicated in the stoichiometric formulation. Pending further tests, all cobalt, nickel, manganese and titanium mole fractions can eventually be changed to optimize the best capacity available from the basic structure. Two continuing tests involve further preferred embodiments of the material wherein cobalt and titanium can be eliminated to reduce cost and simplify the structure of the material.

The quality of the initial starting materials used.

The process used to generate the material.

A semi-solid process, where all the starting soluble salts are mixed in distilled water followed by insoluble salts mixed in slowly, followed by vigorous stirring at 150° Celsius. The gel produced from this process is then heated at 600° Celsius for four hours and the resulting solid product is crushed into a fine powder. The fine powder is then heated at higher temperatures in the range of 800 to 900 Celsius; and the time for calcination is limited to a maximum 8-12 hours.

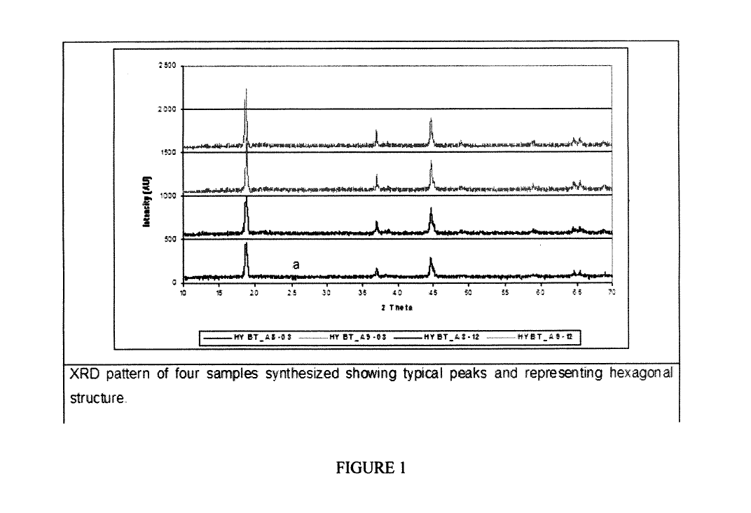

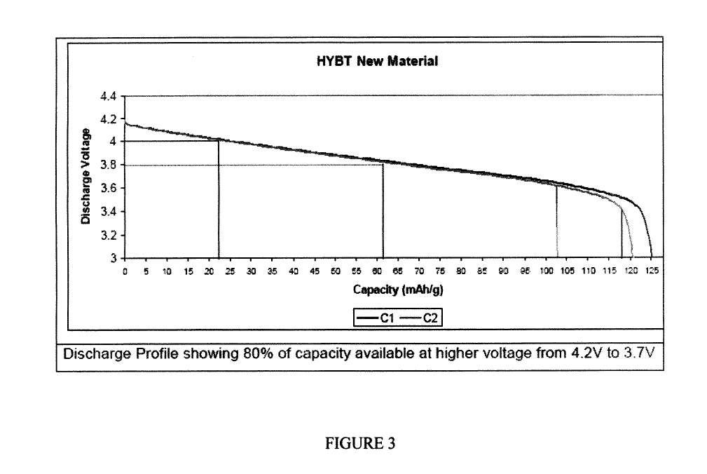

Referring to FIG. 1, the X-ray diffraction pattern demonstrates that the structure is hexagonal without any defects, due to the presence of the different phase. Referring to FIG. 3, submicron particle samples of the cathode material showed an agglomerated morphology. This submicron sized particle is capable of providing a high energy level since the diffusion of lithium ions occur quickly within the structure; and therefore reduces voltage drop during discharge. This type of morphology will keep the operating voltage at a higher level as demonstrated by the discharge curve below.

Initial evaluation of battery performance using the new material.

The new material is being tested for its performance. At present, it has been found to provide a high energy density, with an operating voltage range from 4.2 to 3.7 volts and 100 amperes per hour achievable in this range, out of 125 amperes per hour available. The results of these tests are illustrated in FIG. 3.

What is claimed is:

1. A novel cathode material for a rechargeable battery comprising the formula Li_{1.18}Co_{0.3}Mn_{0.33}Ni_{0.17}Ti_{0.02}O₂.

2. A method of making a novel cathode material comprising the steps of:
a. mixing the starting soluble salts in distilled water;
b. mixing the insoluble salts slowly with vigorous stirring at a temperature of 150° Celsius;
c. heating the resulting gel at 600 degrees Celsius for four hours;
d. crushing the dried material into a fine powder; and
e. heating at higher temperatures in the range of 800 to 900 degrees Celsius, wherein the time for calcination is limited to a maximum 8-12 hours.
